(19) United States
(12) Patent Application Publication
(10) Pub. No.: US 2006/0101481 A1
(43) Pub. Date: May 11, 2006

(54) Anti-derail transmission mechanism for optical pickup

(75) Inventor: Chiao-Fan Huang, Taipei County (TW)

Correspondence Address: BIRCH STEWART KOLASCH & BIRCH, PO BOX 747, FALLS CHURCH, VA, 22040-0747, US

(73) Assignee: BENQ Corporation

(21) Appl. No.: 11/269,546

(22) Filed: Nov. 9, 2005

(30) Foreign Application Priority Data
Nov. 11, 2004 (TW) 93134430

(51) Int. Cl. G11B 7/08; G11B 7/085; G11B 7/09

(52) U.S. Cl. 720/676

(57) ABSTRACT

An anti-derail transmission mechanism for an optical pickup. A connection portion is connected to the optical pickup. An engaging portion is disposed on the connection portion. A first abutting portion on the connection portion and a second abutting portion on the engaging portion forms a clearance therebetween. An elastic element is disposed between the connection portion and the engaging portion, pressing the engaging portion toward a screw rod. The screw rod is disposed on a side of the engaging portion opposite to the connection portion, comprising a threaded portion detachably engaged to the engaging portion. When the screw rod rotates, the threaded portion leads the engaging portion and the connection portion to move straightly along an axial direction of the screw rod. Length of the clearance is shorter than depth of the engagement of the threaded portion and the engaging portion.

### BACKGROUND

The present invention relates to a transmission mechanism for an optical pickup, and particularly to an anti-derail transmission mechanism for an optical pickup in an optical drive.

Generally, the optical pickup in an optical drive is driven by a transmission mechanism. FIG. 1 shows a conventional transmission mechanism for an optical pickup, which comprises a motor 110, a screw rod 120, and a transmission element 130 disposed on the optical pickup 100. The motor 110 provides power for the transmission mechanism. The transmission element 130 comprises a tooth portion 132 engaged with a thread on the screw rod 120. When the motor 110 drives the screw rod 120 to rotate, the tooth portion 132 moves along the thread and leads the transmission element 130 to move straightly along an axial direction of the screw rod 120. Thus, rotation of the motor 110 is transmitted and converted to straight movement of the transmission element 130, and the optical pickup 100 is moved by the transmission element 130.

A clearance may exist between the tooth portion 132 of the transmission element 130 and the thread of the screw rod 120. To eliminate the clearance, a compression spring 150 is disposed on the transmission element 130 to press the tooth portion 132 toward the screw rod 120. Thus, the transmission element 130 keeps in contact with the screw rod 120 in the movement of the optical pickup 100.

The pressing force obtained by the compression spring 150 is critical for elimination of the clearance. A weak pressing force does not totally eliminate the clearance, and a strong pressing force increases load of the motor 110. As a result, a suitable pressing force can be predetermined.

Even with the predetermined pressing force utilized, however, the conventional transmission mechanism has its deficiencies. When an impact acts on the optical drive, the tooth portion 132 may retreat from the thread, and the transmission element 130 and the screw rod 120 temporally lose the contact for a short period of time. It is possible that the optical pickup 100 moves rapidly and collides with other elements in the optical drive in this period of time, resulting in damage or breakage therein.

### SUMMARY

Accordingly, embodiments of the present invention disclose an anti-derail transmission mechanism for an optical pickup, comprising a connection portion connected to the optical pickup, an engaging portion disposed on the connection portion, an elastic element disposed between the connection portion and the engaging portion, and a screw rod disposed on a side of the engaging portion opposite to the connection portion. The connection portion comprises a first abutting portion. The engaging portion comprises a second abutting portion disposed on a side thereof facing the connection portion, and the second abutting portion and the first abutting portion forms a clearance therebetween. The elastic element presses the engaging portion to a direction opposite to the connection portion. The screw rod comprises a threaded portion detachably engaged to the engaging portion, and the threaded portion leads the engaging portion and the connection portion to move straightly along an axial direction of the screw rod when the screw rod rotates. Length of the clearance is shorter than depth of the engagement of the threaded portion and the engaging portion.

A detailed description is given in the following embodiments with reference to the accompanying drawings.

### DESCRIPTION OF THE DRAWINGS

The present invention can be more fully understood by reading the subsequent detailed description and examples with references made to the accompanying drawings, wherein:

FIG. 1 is a schematic view of a conventional transmission mechanism for an optical pickup;

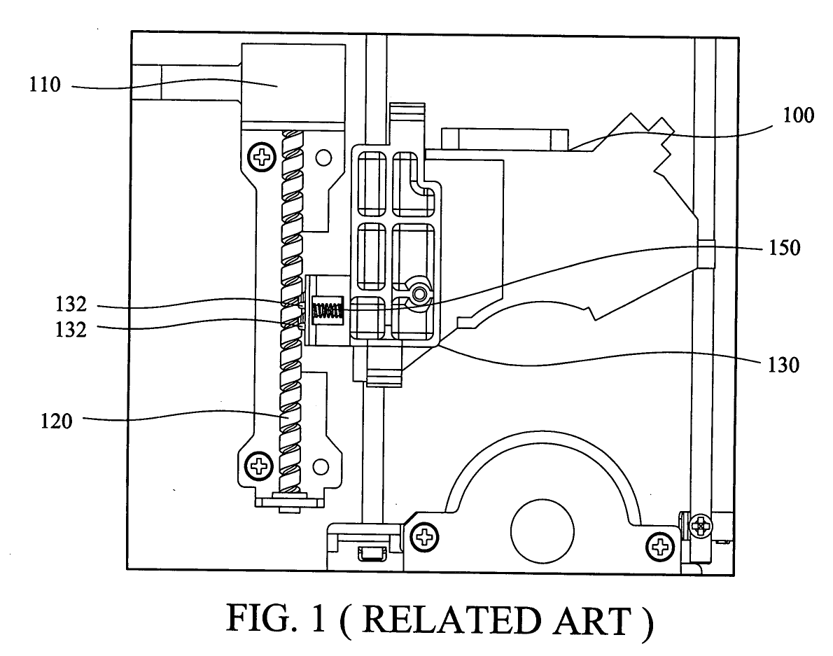

FIG. 2A is a schematic view of an embodiment of the anti-derail transmission mechanism for an optical pickup;

FIG. 2B is a side view of the connection portion 32 and the engaging portion 34 in FIG. 2A;

FIG. 3 is an enlarged view of the portion A in FIG. 2A; and

FIG. 4 is an enlarged view of the portion A in another embodiment.

### DETAILED DESCRIPTION

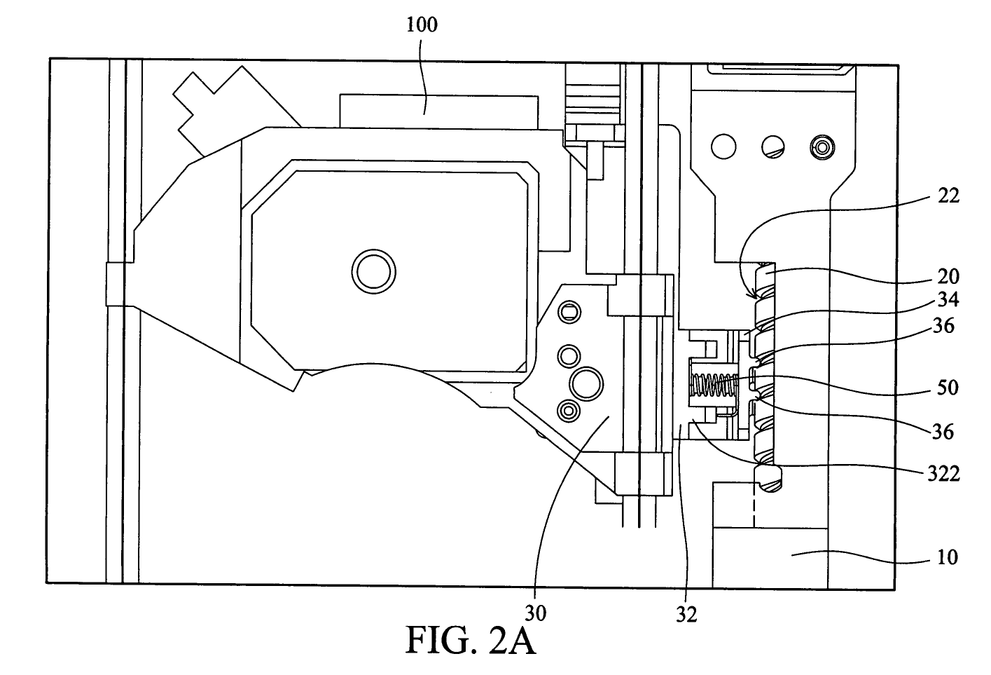

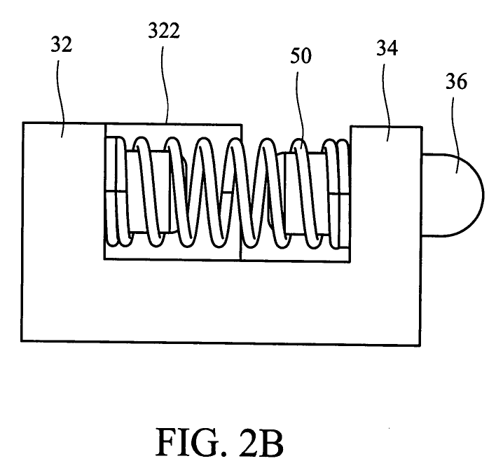

As shown in FIG. 2A, an anti-derail transmission mechanism comprises an optical pickup 100, a motor 10, a screw rod 20, a transmission element 30, and an elastic element 50. The transmission element 30 comprises a connection portion 32 and an engaging portion 34 integrally formed together as a U-shaped structure as shown in FIG. 2B. Thus, the elastic element 50 presses the engaging portion 34 to a direction opposite to the connection portion 32.

The connection portion 32 is connected to the optical pickup 100, and the engaging portion 34 comprises a tooth portion 36 on a side opposite to the connection portion 32. The elastic element 50, which can be a compression spring, presses the engaging portion 34 to a direction opposite to the connection portion 32, i.e. toward the screw rod 20. The screw rod 20 is disposed on the side of the engaging portion 34 opposite to the connection portion 32 and is driven by the motor 10 to rotate. The screw rod 20 comprises a threaded portion 22, which has at least one thread, detachably engaged to the tooth portion 36 of the engaging portion 34. When the screw rod 20 rotates, the threaded portion 22 leads the engaging portion 34 and the connection portion 32 to move straightly along an axial direction of the screw rod 20.

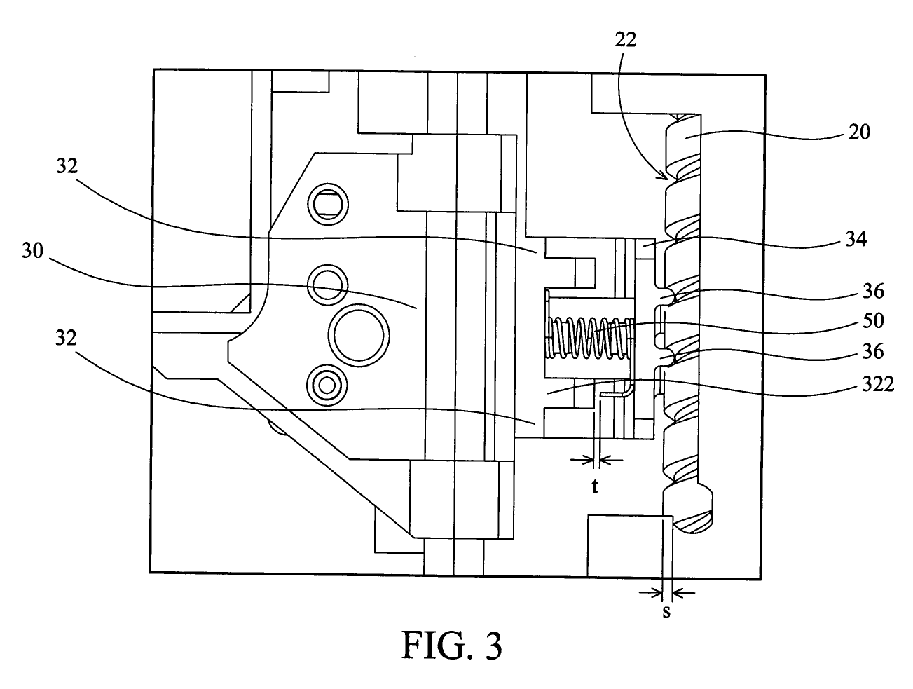

To absorb the impact for the transmission mechanism, the connection portion 32 comprises a first abutting portion 322, which can be an extrusion as shown in FIG. 3, and the engaging portion 34 comprises a second abutting portion 342 disposed on a side facing the connection portion 32, which can be an extended end portion of the elastic element 50 as shown in FIG. 3. The second abutting portion 342 and the first abutting portion 322 forms a clearance t therebetween, and length of the clearance t is shorter than depth s of the engagement of the thread of the threaded portion 22 and the tooth portion 36 of the engaging portion 34. Specifically, the length of the clearance t is shorter than the depth of the thread s.

When an impact acts on the optical drive, the tooth portion 36 of the engaging portion 34 tends to retreat from the thread of the threaded portion 22. The length of the clearance t, however, is shorter than the depth of the thread s, such that the first abutting portion 322 and the second abutting portion 342 abut to each other before the tooth portion retreats from the thread, ensuring the contact between the transmission element 30 and the screw rod 20.

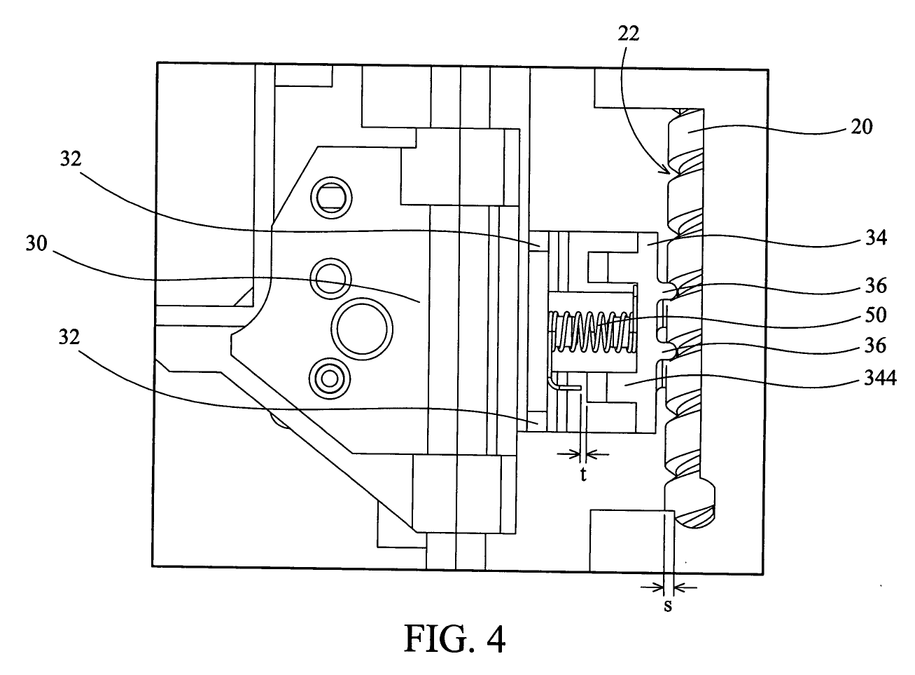

It should be mentioned that the first abutting portion 322 is an extrusion and the second abutting portion 342 is an extended end portion of the elastic element 50 in FIG. 3. In some embodiments, however, adversary arrangement of the first abutting portion 322 and the second abutting portion 342 can be utilized. For example, in another embodiment as shown in FIG. 4, the first abutting portion 324 is an extended end portion of the elastic element 50, and the second abutting portion 344 is an extrusion.

In the above-mentioned embodiment, the first abutting portion 322 and the second abutting portion 342 are disposed near the elastic element 50. In some embodiments, the first abutting portion 322 and the second abutting portion 342 can be preferably arranged according to the structure of the integrally-formed connection portion 32 and the engaging portion 34.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An anti-derail transmission mechanism for an optical pickup of an optical drive, comprising:
a connection portion connected to the optical pickup, the connection portion comprising a first abutting portion;
an engaging portion disposed on the connection portion, the engaging portion comprising a second abutting portion disposed on a side thereof facing the connection portion, the second abutting portion and the first abutting portion forming a clearance therebetween;
an elastic element disposed between the connection portion and the engaging portion, pressing the engaging portion to a direction opposite to the connection portion; and
a screw rod disposed on a side of the engaging portion opposite to the connection portion, the screw rod comprising a threaded portion detachably engaged to the engaging portion, the threaded portion leading the engaging portion and the connection portion to move straightly along an axial direction of the screw rod when the screw rod rotates;
wherein length of the clearance is shorter than depth of the engagement of the threaded portion and the engaging portion.

2. The anti-derail transmission mechanism as claimed in claim 1, wherein the threaded portion comprises a thread, and the engaging portion comprises a tooth portion corresponding to the thread.

3. The anti-derail transmission mechanism as claimed in claim 1, further comprising a motor driving the screw rod to rotate.

4. The anti-derail transmission mechanism as claimed in claim 1, wherein the elastic element comprises a compression spring.

5. The anti-derail transmission mechanism as claimed in claim 1, wherein the first abutting portion is formed by an extended end portion of the elastic element.

6. The anti-derail transmission mechanism as claimed in claim 1, wherein the second abutting portion is formed by an extended end portion of the elastic element.

7. The anti-derail transmission mechanism as claimed in claim 1, wherein the connection portion and the engaging portion are integrally formed as a U-shaped structure.

8. An anti-derail transmission mechanism for an optical drive, comprising:
an optical pickup;
a transmission element comprising a connection portion and an engaging portion integrally formed, the connection portion connected to the optical pickup and comprising a first abutting portion, the engaging portion comprising a second abutting portion disposed on a side thereof facing the connection portion, the second abutting portion and the first abutting portion forming a clearance therebetween;
an elastic element disposed between the connection portion and the engaging portion, pressing the engaging portion to a direction opposite to the connection portion; and
a screw rod disposed on a side of the engaging portion opposite to the connection portion, the screw rod comprising a threaded portion detachably engaged to the engaging portion, the threaded portion leading the engaging portion and the connection portion to move straightly along an axial direction of the screw rod when the screw rod rotates;
wherein length of the clearance is shorter than depth of the engagement of the threaded portion and the engaging portion.

9. The anti-derail transmission mechanism as claimed in claim 8, further comprising a motor driving the screw rod to rotate.

10. The anti-derail transmission mechanism as claimed in claim 8, wherein the elastic element comprises a compression spring.

11. The anti-derail transmission mechanism as claimed in claim 8, wherein the first abutting portion is formed by an extended end portion of the elastic element.

12. The anti-derail transmission mechanism as claimed in claim 8, wherein the second abutting portion is formed by an extended end portion of the elastic element.

13. An optical drive, comprising:
an optical pickup; and
an anti-derail transmission mechanism comprising:
a transmission element comprising a connection portion and an engaging portion integrally formed, the connection portion connected to the optical pickup and comprising a first abutting portion, the engaging portion comprising a second abutting portion disposed on a side thereof facing the connection portion, the second abutting portion and the first abutting portion forming a clearance therebetween;
an elastic element disposed between the connection portion and the engaging portion, pressing the engaging portion to a direction opposite to the connection portion; and
a screw rod disposed on a side of the engaging portion opposite to the connection portion, the screw rod comprising a threaded portion detachably engaged to the engaging portion, the threaded portion leading the engaging portion and the connection portion to move straightly along an axial direction of the screw rod when the screw rod rotates;
wherein length of the clearance is shorter than depth of the engagement of the threaded portion and the engaging portion.
